(19) United States
(12) Patent Application Publication
(10) Pub. No.: US 2006/0254974 A1
(43) Pub. Date: Nov. 16, 2006

(54) Filtration system with bypass valve flow control apparatus and method

(76) Inventors: Ibrahim Khalil, Barrington, IL (US); John W. Shaw, Ponca City, OK (US); C. Alan Peet, Waterman, IL (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 11/344,601

(22) Filed: Feb. 1, 2006

Related U.S. Application Data
(60) Provisional application No. 60/648,702, filed on Feb. 2, 2005.

(51) Int. Cl. B01D 21/24

(52) U.S. Cl. 210/420; 210/433.1; 137/511

(57) ABSTRACT

A fluid filter includes a bypass valve and a pleated media surrounded by a thermoplastic frame. A fluid filter, includes a housing having an inlet and an outlet, a media disposed within the housing, a bypass valve disposed within the housing adjacent the media wherein the bypass valve includes a valve frame, a valve lid that couples to the valve frame, a valve pan that couples to the frame, and a seal door disposed between the valve lid and the valve frame. A method of filtering fluid, includes providing a bypass valve wherein the bypass valve includes a bypass valve seal door, raising the bypass valve seal door along a guide disposed on the bypass valve, passing fluid through the raised bypass valve seal door, lowering the bypass valve seal door along the guide disposed on the bypass valve and ceasing passing fluid through the bypass valve.

### CROSS-REFERENCE TO RELATED APPLICATIONS

This application claims priority to U.S. Provisional Patent Application entitled, FILTRATION SYSTEM WITH BYPASS VALVE FLOW CONTROL APPARATUS AND METHOD, filed Feb. 2, 2005, having a Ser. No. 60/648,702, the disclosure of which is hereby incorporated by reference in its entirety.

### FIELD OF THE INVENTION

The present invention relates generally to sump filters for powered vehicles. More specifically, the present invention concerns a transmission fluid or engine fluid filter having bypass valve.

### BACKGROUND OF THE INVENTION

In a powered vehicle having a lubricated transmission, it is desirable to filter debris (e.g., solid particles, impurities, etc.) out of the fluid in the transmission sump prior to the fluid entering the transmission pump. Known prior art filters utilize a porous filter media fluidly interposed between the sump and the pump to filter the fluid. Unfortunately, these prior art filters may be problematic because in certain conditions (e.g., cold and start-up conditions), the fluid is not adequately sucked through the filter media (e.g., the fluid is too viscous) and thus fluid is not sufficiently provided to the pump.

Some prior art filters utilize a bypass valve to bypass the filter media during these conditions when bypass is desired. These prior art filter bypass valves however, are problematic in that they are costly to construct, unreliable, and ineffective in providing sufficient fluid to the pump during bypass conditions. They are also limited in the size and geometry of the valve.

In response to industry demand, transmission and engine manufacturers continue to optimize the size of their transmissions and engines. Accordingly, transmission and engine manufacturers have required smaller components from their suppliers. The imposition of smaller spatial constraints has introduced a number of challenges to suppliers of transmission and engine components, particularly in the area of filtration.

In many cases, spatial constraints have reduced the available footprint for a powertrain filter. The reduced filter footprint has reduced the available filter media surface area inside the filter. In some cases, the reduced surface area provided by conventional filter media and filter designs has introduced a number of problems including maintaining a low pressure differential across the filter during cold start-up as well as during high temperature operating conditions. Maintaining a low pressure differential across the filter during cold start facilitates quick priming of the fluid pump and during hot operation, it prevents pump cavitation.

One approach to providing a low pressure differential across a filter, given a limited packaging space, has been to use less efficient filtration media. Less efficient media is less restrictive, which permits fluids to pass through the media more freely, resulting in a lower pressure differential. One drawback to this approach, however, is that using filter media that is less efficient allows larger contaminants to pass through the filter. Allowing larger contaminants to pass through the filter media is not desirable because the presence of large contaminants in the system may lead to poor shift quality or premature failure of the transmission. Another drawback to this approach is that as the filter gets smaller, the available media area also decreases, causing the velocity through the media to increase, resulting in lower filtration efficiency.

Accordingly, it is desirable to provide a method and apparatus that combine the ability for thorough fluid filtration and the ability for bypass flow through the use of a bypass valve, in a cost effective, compact manner.

### SUMMARY OF THE INVENTION

The foregoing needs are met, to a great extent, by the present invention, wherein in one aspect an apparatus is provided that in some embodiments combines the ability for thorough fluid filtration and the ability for bypass flow through the use of a bypass valve, in a cost effective, compact manner. In particular, a single unitary frame surrounds both a media, as well as a bypass valve. The bypass valve includes guides that allow for the bypass valve seal door to open and close without becoming misaligned.

In accordance with one embodiment of the present invention, a bypass valve includes a frame, a lid configured to couple to the frame, a pan configured to couple to the frame, and a seal door disposed between the lid and the frame, moveable between an open position and a closed position.

In accordance with another embodiment of the present invention, a fluid filter includes a housing having an inlet and an outlet, a media disposed within the housing, a bypass valve disposed within the housing adjacent the media wherein the bypass valve includes a valve frame, a valve lid configured to couple to the valve frame, a valve pan configured to couple to the frame, and a seal door disposed between the valve lid and the valve frame, moveable between an open position and a closed position.

In accordance with yet another embodiment of the present invention, a media pack includes a fibrous sheet, and a frame surrounding the fibrous sheet.

In accordance with still another embodiment of the present invention, a method of filtering fluid includes providing a bypass valve wherein the bypass valve includes a bypass valve seal door, opening the bypass valve seal door along a guide disposed on the bypass valve to permit fluid through the raised bypass valve seal door, and closing the bypass valve seal door along the guide disposed on the bypass valve to prevent passing fluid through the bypass valve.

In accordance with yet another embodiment of the present invention, a system of filtering fluid includes a filtering means, a filter supporting means surrounding the filtering means, a housing means surrounding the filtering means and the filter supporting means, and a bypass flow means includes a bypass flow supporting means, a first bypass housing means disposed adjacent the bypass flow supporting means, a second bypass housing means disposed adjacent the bypass flow supporting means, a sealing means disposed between the first and the second bypass housing means, moveable between an open position and a closed position, and a guiding means for guiding the sealing means.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of the filter assembly according to an embodiment of the present invention.

FIG. 2 is a longitudinal cross sectional view of the filter assembly according to a preferred embodiment of the invention.

FIG. 3 is a transverse cross sectional view illustrating the filter assembly according to a preferred embodiment of the invention.

FIG. 4 is a perspective view of a media pack according to a preferred embodiment of the present invention.

FIG. 5 is a perspective view of a bypass valve.

FIG. 6 is an exploded perspective view of the media pack and the bypass valve as shown in FIGS. 1, 2 and 3.

FIG. 7 is an exploded side view of the media pack and the bypass valve as per another embodiment of the present invention.

### DETAILED DESCRIPTION OF THE INVENTION

The invention will now be described with reference to the drawing figures, in which like reference numerals refer to like parts throughout. An embodiment in accordance with the present invention provides a filter assembly having a bypass valve and pleated media, enclosed in a filter housing. The bypass valve frame and pleated media frame may be formed of a unitary construction. The bypass valve includes guides that allow for the bypass valve seal door to open and close without becoming misaligned.

An additional preferred embodiment of the present invention includes the ability to use the pleated media-bypass valve assembly in any type of fluid housing, including all plastic filters and composite filters that are formed with both a metal cover and a plastic cover. Thus, the presently claimed invention has broad application for fluid filtration and may be used in engines, transmission or other machinery.

Yet another preferred embodiment of the present invention includes molding a plastic or thermoplastic resin over the pleated media to provide the external structure for the media. The pleated media may be made of any type of material capable of filtering fluids. Molding the plastic around the media allows for additional structure to be added to the media, such as the bypass valve. The filter assembly also includes supports or pinch points formed adjacent the media from the thermoplastic resin to provide for spacing between the media and the filter housing. Such spacing facilitates fluid flow. The supports may be formed on either side of the media, extending toward both the upper and lower covers of the filter housing.

Forming the resin over the media also allows for a compact and cost effective way of creating additional beneficial structure and function to the filter assembly such as a bypass valve. Being able to form the media, the pinch point supports and the bypass valve in a more efficient manner reduces cycle time and allows for a much better filter at a lower cost.

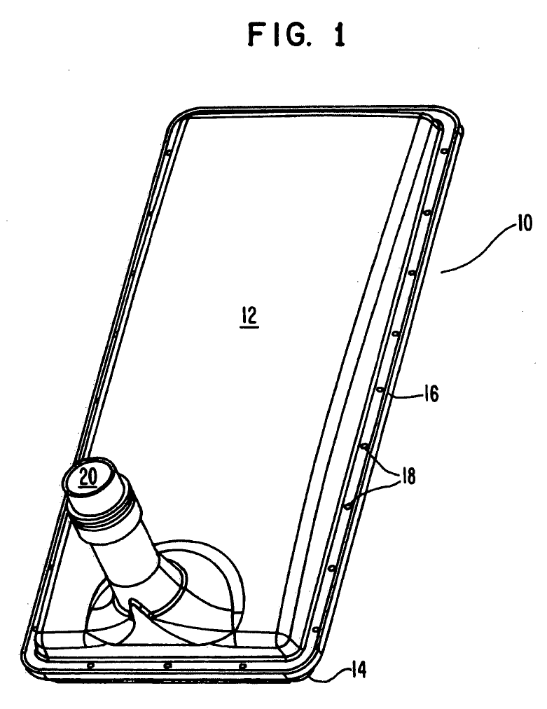

FIG. 1 is a perspective view of the filter assembly 10 according to an embodiment of the present invention. The filter assembly 10 has a cover 12 and a pan 14 sealed together at the edges 16 of cover 12 and pan 14. The cover 12 and pan 14 may be sealed using a plurality of fasteners 18 or are sealed in a variety of other ways. The filter assembly 10 also has an outlet 20 extending longitudinally from the cover 12.

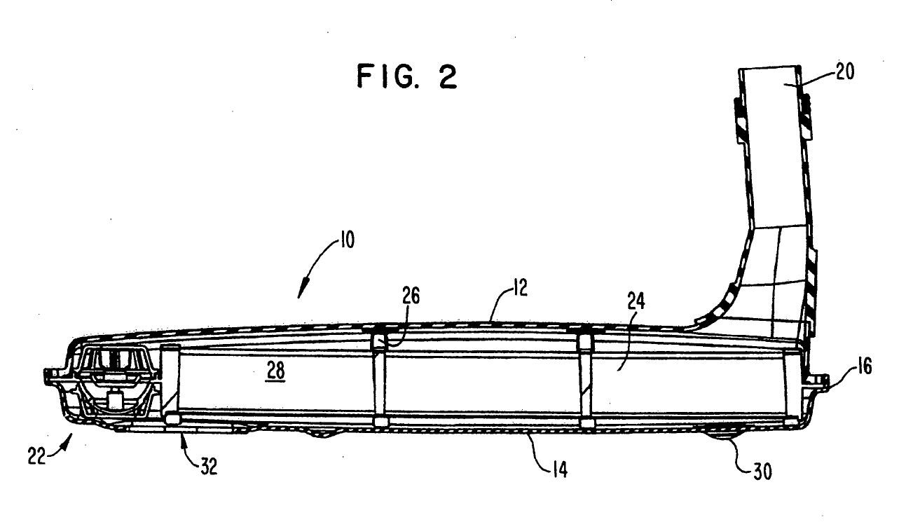

FIG. 2 is a longitudinal cross sectional view of the filter assembly 10 according to a preferred embodiment of the invention. A bypass valve assembly 22 is disposed at a distal end from the outlet 20. Adjacent the bypass valve assembly 22, proximal to the outlet 20, is disposed a pleat pack or a media pack 24. The media pack 24 includes a frame 26 and media 28. The frame 26 may be formed of any suitable material, preferably a thermoplastic resin. The media 28 may be formed of any suitable material, preferably a fibrous material. The filter assembly 10 further includes spacers 30 formed on the pan 14 to provide a space between the pan 14 and the floor of fluid container in which the filter assembly 10 is placed. For example, the fluid container may be a transmission pan, an engine pan or any such machinery or fluid application requiring fluid filtration. Lastly, an inlet 32 is disposed at a distal end from the outlet 20, formed on the pan 14.

FIG. 2 also illustrates the various pinch points 34 or supports 36 molded onto the frame 26 to provide integrity to the filter housing cover 12. It can also be seen that the pinch points 34 create a space for the fluid flow. In addition, this figure also shows the bypass valve 22 with the placement guides 44 adjacent the shafts or cylinders, formed on the bypass valve cage.

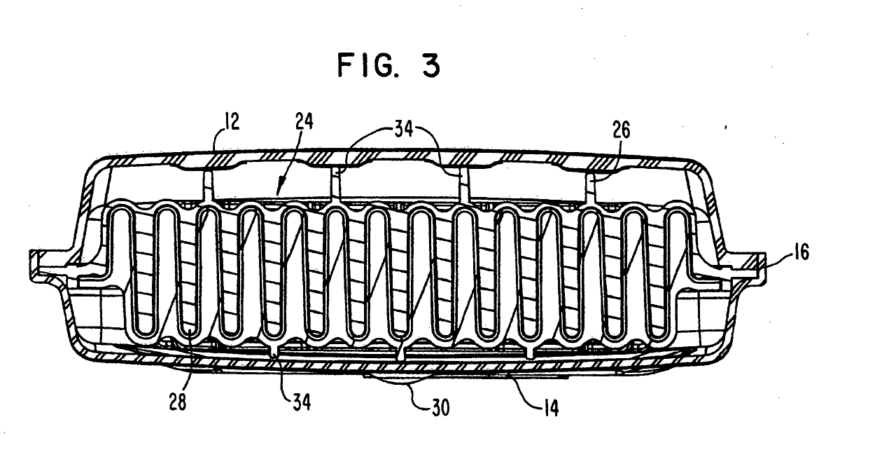

FIG. 3 is a transverse cross sectional view illustrating the filter assembly 10 according to a preferred embodiment of the invention. The media pack 24 is shown with the frame 26, media 28 and a plurality of pinch points 34 on either side of the frame 26. FIG. 3 also illustrates the pleated nature of the media 28 and the molded structure that forms the pinch points 34. It can be seen here as well, that the pinch points 34 serve to provide greater strength for the filter housing walls and create a space for the fluid flow. Throughout the media pack 24, the resin is molded adjacent the media 28.

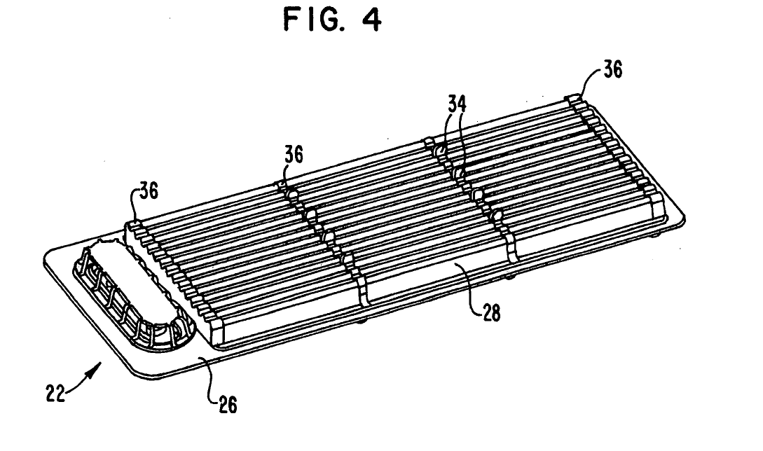

FIG. 4 shows the filter insert including the pleated media 28, the pinch points 34, the external structure of the molded resin adjacent the media 28 and the bypass valve 22. It can be seen that the media 28 is arranged in a longitudinal fashion and that there are several areas across the media 28 where the frame 26 supports the media 28. Although four such supports 36 are illustrated, any number of supports 36 may be implemented. Pinch points 34 may be arranged on the supports 36.

The pleated media 28 in a preferred embodiment, has pleats running longitudinally to the filter housing, allowing for fewer pleats but with longer lengths. This configuration increases the total surface area available for filtration. This pleat direction also allows the fluid to flow well. In addition, this longitudinal pleating allows for more efficiency in the packaging of the pleated media. This reduces cost in reducing the packaging material required and costs associated with shipping.

Supports 36 serve several functions. They provide support to the housing in that the housing is kept rigid. The pinch points 34 also greatly increase strength in the housing. Further, they decrease detrimental deformation of the cover 12 or pan 14 under load, allowing larger filters with thinner housing walls which leads to overall cost reduction of the entire filter assembly. Moreover, these supports 36 and pinch points 34 allow for a space between the media 28 and the cover 12 or pan 14 through which the fluid may also flow freely. Furthermore, during bypass filtration, the fluid may flow freely through the space created by the supports, between the media and the housing cover especially because under cold-start conditions, the fluid is more viscous.

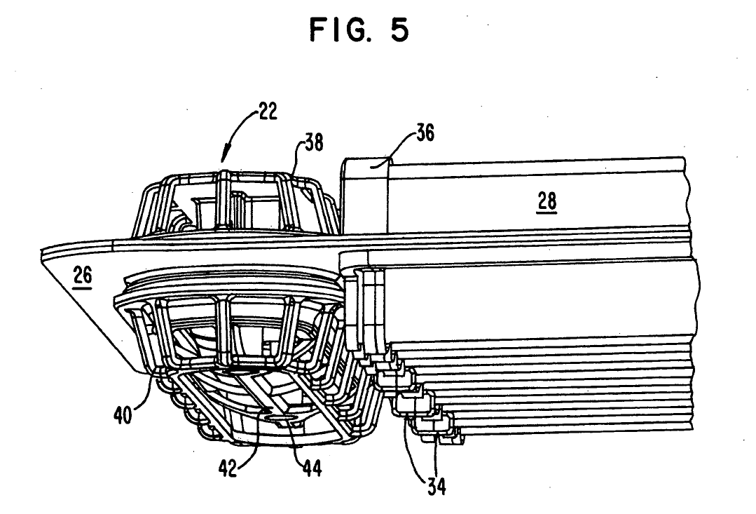

FIG. 5 is a perspective view of the bypass valve 22 as shown in FIG. 4. The bypass valve 22 has a valve lid 38 and a valve pan 40. Both the valve lid 38 and the valve pan 40 are similar in structure and may be mirror images of each other. They both have an open lattice structure like a cage, to permit fluid to easily pass through. The valve pan 40 may have a mesh screen (not shown) attached to it, to provide some filtration of the fluid being bypassed from the media 28. This mesh screen would provide a coarse filtration of the fluid to prevent large particles from damaging the transmission, engine or other machinery, in which this filter assembly 10 may be placed.

The bypass valve 22 also has a valve frame 42 formed on the frame 26. The valve frame 42 also has an open lattice structure and supports a guide 44. Here, two guides 44 are shown, however any number of guides may be implemented. The guides 44, formed of unitary construction with the valve frame 42, extend vertically upward. The guides 44 may be of any shape, for example, of a cylindrical nature, and may be hollow. Although shown here formed on the valve frame 42, the guides 44 may be formed on the valve pan 40. If the guides 44 are formed on the valve pan 40, a valve frame 42 may not be used.

The valve lid 38 and valve pan 40 are attached to the valve frame 42 by any means known in the art. They may be made of thermoplastic, metal, or any suitable material. They may also be of any desired configuration. Often bypass valves have been circular to prevent misalignment. Misalignment may occur when the valve door is repeatedly raised and lowered to permit bypass flow. When returning to close off the bypass flow, misalignment of a valve door may occur. Such misalignment is detrimental to fluid filtration as fluid may continue to proceed through the bypass valve even when the filter is operating in such a manner as to not require bypass flow. Such flow will contain unintended impurities because bypass flows are not as thoroughly filtered as fluid flow through media. Here, however, the shape may be of any desired configuration because guides 44 are used to prevent misalignment. The valve lid 38 and valve pan 40 are formed in a cage-like manner with an open lattice structure, allowing viscous fluid to flow more freely through the bypass valve 22. The bypass valve 22 structure also includes several shafts or cylinders that serve to prevent misalignment.

This ability to keep the valve appropriately aligned at all times allows for a variety of shapes and sizes and removes any restraints placed by capacity requirements for the fluid flow. This non-circular design of the bypass valve 22 allows for the ability to maximize the bypass fluid flow. It also allows for various configurations in designing such a filter assembly 10 to include both a pleated media 28 and a bypass valve 22.

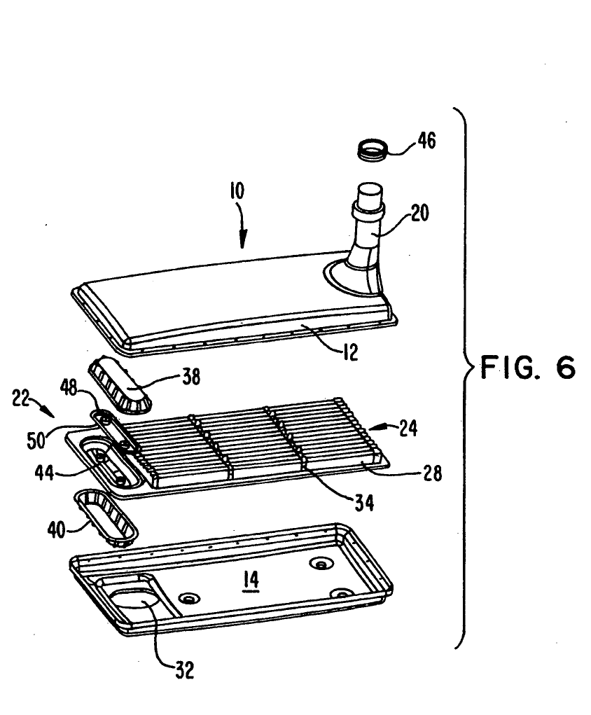

FIG. 6 is an exploded perspective view of the entire assembly. The figure illustrates the filter lip seal 46 that couples with the filter outlet 20. The filter outlet 20 is formed on the cover 12. The media pack 24 includes the pleated media 28 and the pinch points 34 formed from the molded frame 26. The bypass valve 22 contains a valve lid 38 that rests on the frame 26.

Below the valve lid 38 is disposed a seal door 48. The seal door 48 contains recessions 50 that accommodate and receive the guides 44. The recessions 50 are shaped to accept the guides 44 and rest atop the guides 44. The seal door 48 is raised to permit fluid to pass through the bypass valve 22. As the seal door 48 is raised, recessions 50 ride along the guides 44 and move upward. When bypass flow is no longer needed, the seal door 48 lowers back down to close off the bypass valve 22. When the seal door 48 lowers back down toward the valve frame 42, the recessions 50 maintain contact with the guides 44 and ride the guides 44 back down. This relationship between the guides 44 and the recessions 50 prevents misalignment of the seal door 48 as it is repeatedly raised and lowered.

A valve pan 40 is disposed below the guides 44. The valve pan 40 may have a mesh screen (not shown) attached for coarsely filtering the bypass flow. The assembly also contains a filter pan 14 with the fluid inlet 32.

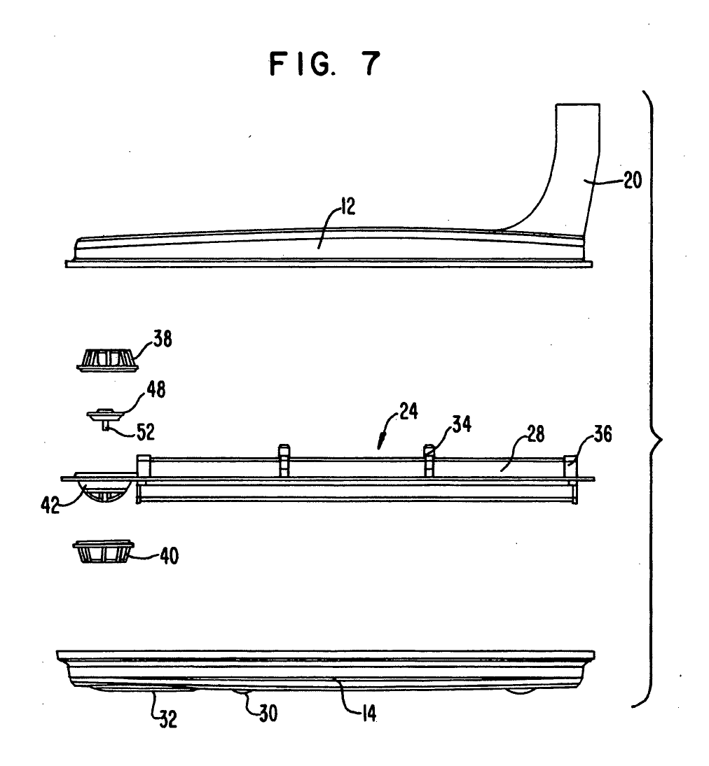

FIG. 7 is an exploded side view of the media pack 24 and the bypass valve 22 as per another embodiment of the present invention. In this embodiment, the seal door has guides 52, rather than recessions 50. Correspondingly, valve frame 42 will have recessions (not shown) to accommodate and receive the guides 52.

Although an example of the filter assembly is shown using the media pack along with a bypass valve for a transmission filter, it will be appreciated that other types of pleated configurations along with bypass valves can be used and that various other configurations of pleated and non-pleated media may be used to create the molded filter assembly. It may also be possible to form a variety of filters with various configurations of the bypass valve. Also, although the device is useful in the automotive industry, it can be used in any type of system requiring fluid filtration, including engines and engine filters.

The many features and advantages of the invention are apparent from the detailed specification, and thus, it is intended by the appended disclosure to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A bypass valve, comprising:
a frame;
a lid configured to couple to the frame;
a pan configured to couple to the frame; and
a seal door disposed between the lid and the frame, moveable between an open position and a closed position.

2. The bypass valve of claim 1, wherein the lid comprises a lattice structure.

3. The bypass valve of claim 1, wherein the pan comprises a lattice structure.

4. The bypass valve of claim 1, wherein the pan comprises a mesh screen for filtering fluid.

5. The bypass valve of claim 1, wherein the frame comprises a lattice structure.

6. The bypass valve of claim 1, wherein the frame comprises a guide.

7. The bypass valve of claim 6, wherein the guide comprises a projection.

8. The bypass valve of claim 6, wherein the seal door comprises a seat for accepting the guide.

9. The bypass valve of claim 1, wherein the pan comprises a guide.

10. The bypass valve of claim 9, wherein the seal door comprises a seat configured to accept the guide.

11. A fluid filter, comprising:
a housing having an inlet and an outlet;
a media disposed within the housing;
a bypass valve disposed within the housing adjacent the media wherein the bypass valve comprises:
a valve frame;
a valve lid configured to couple to the valve frame;
a valve pan configured to couple to the frame; and
a seal door disposed between the valve lid and the valve frame, moveable between an open position and a closed position.

12. The fluid filter of claim 11, wherein the media is surrounded by a media frame.

13. The fluid filter of claim 12, wherein the media frame and the valve frame are of unitary construction.

14. The fluid filter of claim 12, wherein the media frame comprises a plurality of pins extending outwardly toward the housing.

15. The fluid filter of claim 14, wherein the media frame and the media are of unitary construction.

16. The fluid filter of claim 14, wherein the media frame comprises a thermoplastic.

17. The fluid filter of claim 11, wherein the valve frame comprises a guide.

18. The fluid filter of claim 11, wherein the seal door comprises a seat for accepting a guide.

19. The fluid filter of claim 11, wherein the media is pleated.

20. A media pack, comprising,
a fibrous sheet; and
a frame surrounding the fibrous sheet.

21. The media pack of claim 20, wherein the fibrous sheet is pleated.

22. The media pack of claim 20, wherein the frame and the fibrous sheet are of unitary construction.

23. The media pack of claim 20, wherein the frame comprises a spacer for supporting a housing surrounding the frame.

24. The media pack of claim 20, wherein the frame comprises a thermoplastic.

25. The media pack of claim 20, wherein the frame is molded onto the fibrous sheet.

26. A method of filtering fluid, comprising:
providing a bypass valve wherein the bypass valve comprises a bypass valve seal door;
opening the bypass valve seal door along a guide disposed on the bypass valve to permit fluid through the raised bypass valve seal door; and
closing the bypass valve seal door along the guide disposed on the bypass valve to prevent passing fluid through the bypass valve.

27. The method of claim 26, wherein the bypass valve comprises a bypass valve pan and a bypass valve lid.

28. The method of claim 27, wherein the bypass valve pan and the bypass valve lid comprise a lattice structure.

29. The method of claim 26, wherein the bypass valve comprises a bypass valve frame, wherein the guide is disposed on the bypass valve frame.

30. The method of claim 26, wherein the bypass valve seal door has a recession for accepting the guide.

31. A system of filtering fluid, comprising:
a filtering means;
a filter supporting means surrounding the filtering means;
a housing means surrounding the filtering means and the filter supporting means; and
a bypass flow means comprising:
a bypass flow supporting means;
a first bypass housing means disposed adjacent the bypass flow supporting means;
a second bypass housing means disposed adjacent the bypass flow supporting means;
a sealing means disposed between the first and the second bypass housing means, moveable between an open position and a closed position; and
a guiding means for guiding the sealing means.

32. The system of claim 31, wherein the filter supporting means comprises a frame.

33. The system of claim 32, wherein the frame is formed of a thermoplastic resin.

34. The system of claim 31, wherein the filtering means is a filter media.

35. The system of claim 34, wherein the filter media is pleated.

36. The system of claim 31, wherein the filter supporting means and the bypass flow supporting means are formed of unitary construction.
